(19) United States
(12) Patent Application Publication
(10) Pub. No.: US 2016/0348204 A1
(43) Pub. Date: Dec. 1, 2016

(54) METHOD FOR IMPROVING THE STRUCTURE OF A STEEL COMPONENT AFTER HEATING AND STELL COMPONENT OBTAINED BY THE METHOD

(71) Applicant: Aktiebolaget SKF, Goteborg (SE)

(72) Inventor: Staffan Larsson, Goteborg (SE)

(73) Assignee: Aktiebolaget SKF, Goteborg (SE)

(21) Appl. No.: 15/163,636

(22) Filed: May 24, 2016

(30) Foreign Application Priority Data
May 25, 2015 (SE) 1550662-9

(51) Int. Cl. C21D 9/40; C21D 6/00; C21D 1/25; F16C 33/62; F16C 33/64

(52) U.S. Cl. CPC C21D 9/40; F16C 33/62; F16C 33/64; C21D 1/25; C21D 6/004; C21D 6/005; C21D 6/008; C21D 2211/002; C22C 38/50

(57) ABSTRACT

The present disclosure relates to a method for improving the steel structure of a steel component after heating including the steps of heating the steel component to a temperature of at least 1100° C., quenching the steel component to a temperature above the martensite start temperature (Ms) to form bainite, and maintaining the steel component at that temperature for a holding time sufficient for transformation of all austenite to bainite, re-heating the steel component to a temperature of at least 580° C. but below the Ac₁ transformation temperature, and maintaining the steel component at that temperature for the steel component to exhibit a hardness of 45 Rockwell hardness C or below, and cooling the steel component.

### TECHNICAL FIELD

This disclosure pertains to a method for improving a steel structure for a steel component after heating and a steel component obtained by the method.

### BACKGROUND

Steel components, such as bearing components, are subjected to stringent demands with respect to strength, length of use and microstructural stability against aging. These steel components require a material that in the machined state has a homogenous microstructure with very finely distributed globular carbides. There is simultaneously a constant strive towards cost-efficiency and being competitive both in terms of costs and by the quality needed for the field of application.

During production of bearing components the components are heated to high temperatures, such as during welding, hot rolling and forging of tubes and bars, hot drawing of wires and hot rolling and forging of rings. After the heating steps the resulting steel components are often collected and left to cool. When heated to such high temperatures the microstructure of the steel becomes affected. Also, the conditions during the subsequent cooling will impact the microstructure of the steel. When collected and left to cool together, the components may cool down at different cooling rates, leading to inhomogeneous microstructures between the components. For the components having cooled down slowly, grain boundary cementite may have formed and for components allowed to cool more rapidly there is a risk of martensite formation. In order to restore and normalize the microstructure of the heated and subsequently cooled rings the rings need to be re-annealed. The annealing of such rings may take considerable time, such as between 24 hours and 48 hours.

Flash-butt welding, or “flash welding” is a resistance welding technique for joining segments of metal, such as a steel components, in which the segments are aligned end to end and electronically charged, producing an electric arc that melts and welds the ends of the segments, yielding an exceptionally strong and smooth joint.

A flash butt welding circuit usually consists of a low-voltage, high-current energy source (usually a welding transformer) and two clamping electrodes. The two segments that are to be welded are clamped in the electrodes and brought together until they meet, making light contact. Energizing the transformer causes a high-density current to flow through the areas that are in contact with each other. Flashing starts, and the segments are forged together with sufficient force and speed to maintain a flashing action. After a heat gradient has been established on the two surfaces to be welded, an upset force is applied to complete the weld. This upset force extrudes slag, oxides and molten metal from the weld zone, leaving a welding accretion in the colder zone of the heated metal. The joint is then allowed to cool slightly before the clamps are opened to release the welded article. The welding accretion may be left in place or removed by shearing while the welded article is still hot, or by grinding, depending on the requirements. Although flash butt welding is a simple and efficient welding technique, the physical properties of a component in the vicinity of its weld joint(s) may be adversely affected by the flash butt welding, because of defects, such as weld/quench cracks, which occur during and after the flash butt welding, and since the microstructure of the steel in a heat affected zone (HAZ) around a weld joint will be modified by the flash butt welding.

### SUMMARY

One object of the present disclosure is to provide an effective and highly time-saving method for improving a steel structure after heating to high temperatures, such as after welding, hot rolling and forging of tubes and bars, hot drawing of wires and hot rolling and forging of rings, to provide a steel component, such as a bearing component, having improved microstructure and thus a correct hardened microstructure in order to arrive at improved wear resistance, such as improved rolling contact fatigue properties. Furthermore, since the method according to the present disclosure may be performed in-line with the heating step, the energy resulting from the first heating step may be utilized during the subsequent restoration steps, resulting in savings in terms of energy consumption.

This object is achieved by a method for improving a steel structure after heating according to claim 1.

As such, the present disclosure relates to a method for improving the steel structure of a steel component after heating comprising the steps of a) heating the steel component to a temperature of at least 1100° C., b) quenching the steel component to a temperature above the martensite start temperature (Ms) to form bainite, and maintaining the steel component at that temperature for a holding time sufficient for transformation of all austenite to bainite, c) re-heating the steel component to a temperature of at least 580° C. but below the Ac₁ transformation temperature, and maintaining the steel component at that temperature for the steel component to exhibit a hardness of 45 Rockwell hardness C or below, d) cooling the steel component.

Optionally, step a) may comprise forming the steel component by hot rolling, forging and/or hot drawing at a temperature of at least 1100° C.

Optionally, step a) may comprise welding the steel component at a temperature of at least 1100° C. to form a welding joint, wherein the welding joint optionally may be a flash-butt welded joint.

Optionally, step b) may comprise quenching the steel component to a temperature above Ms and below 450° C. to form bainite, and maintaining the steel component at that temperature for a holding time sufficient for transformation of all austenite to bainite.

Optionally, step b) may comprise quenching the steel component to a temperature of 300° C. to 350° C. to form bainite, and maintaining the steel component at that temperature for a holding time sufficient for transformation of all austenite to bainite.

Optionally, the steel component is a high-carbon steel component.

Optionally, the steel component is a bearing component, such as a bearing ring.

The present disclosure also concerns a steel component that is manufactured using a method according to any aspects of the invention. The present disclosure also concerns a steel component comprising a welding joint, such as a flash butt welded joint, which is manufactured using a method according to any of the aspects of the disclosure. Optionally, the steel component may be a bearing ring, for use in a bearing, such as a roller bearing, a needle bearing, a tapered roller bearing, s spherical roller bearing, a tyroidal roller bearing, a thrust bearing or a bearing for any application in which it is subjected to alternating Hertzian stresses, such as rolling contact or combined rolling and sliding. The bearing may for example be used in automotive, wind, marine, metal producing or other machine applications which require high wear resistance and/or increased fatigue and tensile strength.

### BRIEF DESCRIPTION OF THE DRAWINGS

The present disclosure will hereinafter be further explained by means of non-limiting examples with reference to the appended schematic figures herein;

FIG. 1 shows a method according to one embodiment of the present disclosure.

FIG. 2 shows an open ring clamped to be flash butt welded according to one embodiment of the present disclosure.

FIG. 3 shows a bearing according to one embodiment of the present disclosure.

### DETAILED DESCRIPTION

During production of bearing components by welding, hot rolling and forging of tubes and bars, hot drawing of wires and hot rolling and forging of rings the steel is heated to high temperatures, such as above about 1200° C. The components resulting from these metal forming processes are subsequently normally collected in, for example, a container and left to cool.

When heated to such high temperatures, the microstructure of the steel is affected, and also the cooling rate for the steel will affect the microstructure. When left to cool together, the components may cool down at different cooling rates leading to inhomogeneous microstructures between the components. For the components having cooled down slowly, grain boundary cementite may have formed and for components allowed to cool, more rapidly there is a risk of martensite formation, both cases leads to undesired microstructure.

When forming high carbon steel, which is suitable in for example bearing components 7,8, 9, such as bearing rings 7,8, the steel needs to be in soft annealed condition to avoid cracking. This implies a fine-grain homogenous microstructure of the steel comprising spheroidised carbides. In order to restore and normalize the microstructure of the heated and subsequently cooled components the components need to be annealed. The annealing of such components may take considerable time, such as between 24 hours and 48 hours. This annealing process including re-heating of the steel components results in high energy consumption.

By “high carbon steel” herein is meant a carbon steel with a carbon content of about 0.6 weight % or higher, such as about 0:6 to about 1.20 weight %, such as about 0.8 to about 1.20 weight %. The high carbon bearing steel may be 100Cr6/SAE52100 and 100CrMo7-4 from AB SKF.

Optionally, the steel may have the following composition in weight %:

| | |
|---|---|
| C | 0.6-1.2 |
| Si | 0-0.25 |
| Mn | 0.1-1.0 |
| Cr | 0.01-2.2 |
| Mo | 0.01-1.0 |
| Ni | 0.01-2.0 |
| S | 0-0.002 |
| P | 0-0.010 |
| Cu | 0-0.45 |
| Al | 0.010-1.0 |
| As | 0-0.1 |
| Pb | 0-0.01 |
| Ca/Pb/Ti/N/H | 0-0.0001 |

balance Fe and normally occurring impurities.

Annealing is a well-known heat treatment method that alters the physical properties of the material, steel herein, to increase its ductility and to make it more workable. It involves heating a material to above its glass transition temperature, maintaining a suitable temperature, and then cooling. Annealing can induce ductility, soften material, relieve internal stresses, refine the structure by making it homogeneous, and improve cold working properties.

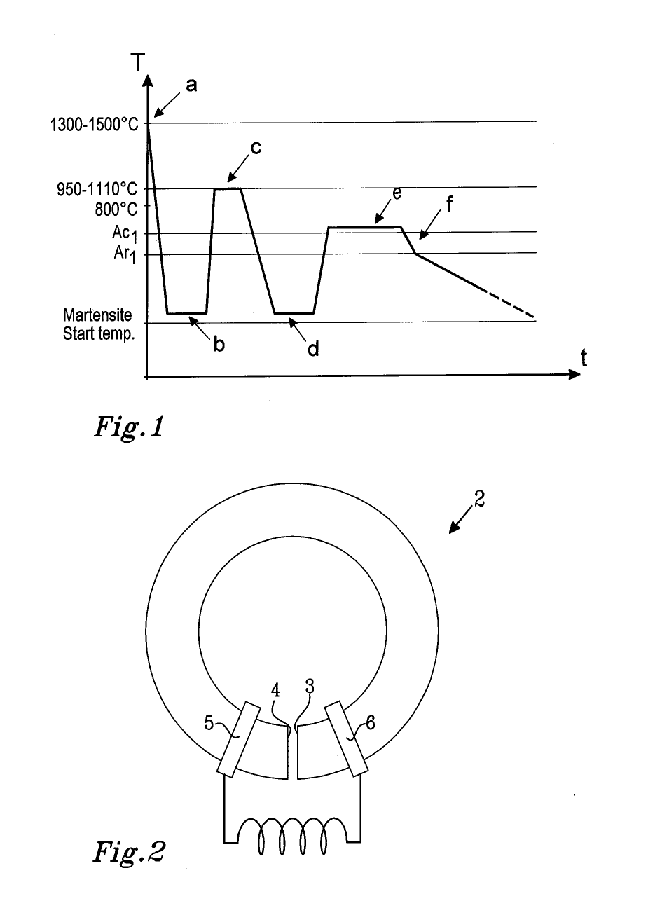

FIG. 1 shows a method according to the present disclosure. This method is a highly cost-efficient method, mainly suitable for applications wherein the steel components are subjected to a lower wear. The method comprises the steps a) of heating a steel component to a temperature of at least 1100° C., such as at least 1200° C. Instead of allowing the components to cool down to about room temperature the steel components may directly be subjected to a method comprising the steps b) to d). Subjecting the steel components directly to these method steps has been found to significantly enhance the microstructure of the steel in terms of ductility in a highly cost-efficient in-line method.

The method according to the present disclosure thus comprises a further step b), wherein the steel components are subjected to quenching, to a temperature above the martensite start temperature (Ms) to form bainite, such as 10 to 20° C. above the Ms temperature, and maintained at that temperature for a holding time sufficient for transformation of all austenite to bainite. The purpose of this step is to avoid formation of martensite form bainite and start to regain the desired microstructure. Normally, bainite is formed in the temperature interval of above Ms and below 450° C. So, this step b) may comprise quenching the steel component to a temperature above Ms and below 450° C. To further minimize the risk of grain boundary cementite step b) may comprise quenching the steel components to a temperature of 300 to 350° C.

This step may be carried by means of a fluidized bed, immersion in a salt bath, in liquid nitrogen or in air vapour or the like.

To detect and determine when a transformation of all austenite into bainite has been completed the skilled person may use a dilatometer. Dilatometry is an experimental technique that allows the solid state phase transformations occurring in different materials, particularly steels, to be detected and followed. Phase transitions bring about volume changes, and these changes can be recorded by studying the length changes of samples with normalized dimensions during their heating or cooling. The variations in the rate and direction of length change versus temperature (dilation/contraction) allow the temperatures at which phase transformations of steel take place to be determined.

One purpose with this quenching step is also to avoid formation of grain boundary cementite. This may be ensured by quenching the steel component at a cooling rate fast enough to avoid grain boundary cementite, as may be determined by reference to a CCT diagram. The CCT diagram may have been previously prepared, stored in a database, or otherwise made available for control of the cooling rate. CCT diagrams may of course also be prepared and used for determining the temperatures and cooling rates to apply during the quenching and heating steps.

When the desired cooling has been achieved, the steel components may be transferred to a furnace for isothermal hold at a temperature in the range of 150-260° C. The aim is to reach a temperature of around 320° C. for the steel component and keep this temperature for around 2 hours, such as at least 1.5 hours. The purpose with this is to ensure complete transformation of all the austenite to bainite, but also to facilitate the handling of the steel components and to avoid to high furnace temperatures when loading the steel components.

The method furthermore comprises the step c) re-heating the steel component to a temperature of at least 580° C. but below the Ac₁ transformation temperature, and maintaining the steel component at that temperature for a holding time sufficient for the steel component to exhibit a hardness of 45 Rockwell hardness C or below. Since all austenite has been completely transformed into bainite in the preceding step and essentially no cooling perlite is present the temperature in this step does only need to be raised to at least 580° C. in step c) and may be kept below 950° C. to render the steel more ductile and formable. It has been found that heating does not need to reach higher temperature in order to sufficiently improve the microstructure of the steel when the steel component is held in this temperature interval for a holding time sufficient for the steel component to exhibit hardness of 45 Rockwell hardness C or below. The resulting process will thus be a highly cost-efficient restoration process. The steel components may also be held in this temperature interval for a holding time sufficient for the steel components to exhibit Brinell hardness number of between 280 and 320 HB10/3000, which is less hard than 45 Rockwell hardness C. This reduced hardness requires a longer holding time and will be a compromise between cost and ductility. The steel components are subsequently let to cool, in a step d), to room temperature by any type of cooling, such as for example air cooling, meaning that no controlled cooling is needed which is logistically highly efficient.

With “Ac₁ transformation temperature” is meant herein the onset temperature of ferrite to austenite formation.

Rockwell hardness is herein measured in accordance with standard method ISO 6508-1, scale C.

Hence, by means of a highly cost-efficient method the properties of the resulting steel components, such as bearing components, have been found to greatly enhanced in terms of ductility, which is crucial for the functionality and the wear resistance during use of bearing components in bearings.

Furthermore, the restoration method according to the present disclosure takes around 7-8 hours compared to a conventional annealing process taking 24 to 48 hours. The present invention has a further advantage in that the restoration method may be carried out in-line with the heating process, and may thus use some of the energy produced during this process instead of the energy being lost by conversion into heat.

One way of manufacturing bearing components 7,8,9, such as bearing rings 7,8 includes flash butt welding. Soft annealed steel plates are then rolled and bended in a rolling machine to form open bearing rings 2. When forming high carbon steel, which is suitable in for example bearing rings, the steel needs to be in soft annealed condition to avoid cracking. This implies a fine-grain homogenous microstructure of the steel comprising spheroidised carbides. The ends 3,4 of the open bearing rings 2 may be flash butt welded together to form a bearing ring 8,9.

When flash butt welding an open ring 2, as shown in FIG. 2, the ring is clamped near the ends 3,4 that are to be welded, using two clamping electrodes 5,6, and the ends 3,4 are then brought together until they meet, making light contact, and form a flash butt welding joint. While the ring in general is heated to about 200° C. during welding, the heat formed at the welding joint, between the clamps, is about 1300 to about 1500° C. The microstructure of the resulting steel ring 7,8 in the area between the logs, heat affected zone (HAZ), is thus affected and the properties of the steel component in the HAZ are deteriorated. For a bearing ring 7,8 the rolling contact fatigue properties of this zone are inadequate.

It has been found that if subjecting the steel components after welding, such as flash-butt welding, to a method according to the present disclosure comprising the steps b) to d), the ductility of the steel components in the heat affected zone becomes substantially improved, leading to improved wear resistance, such as improved rolling contact fatigue properties and thus an prolonged bearing life.

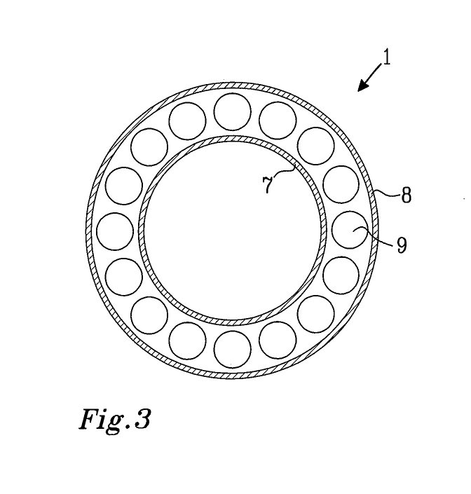

FIG. 3 shows an example of a bearing 1, namely a rolling element bearing that may range in size from 10 mm diameter to a few metres diameter and have a load carrying capacity from a few tens of grams to many thousands of tonnes. The bearing 1 according to the present disclosure may namely be of any size and have any load-carrying capacity. The bearing 1 has an inner ring 7 and an outer ring 8, one or both which may be constituted by a ring according to the present disclosure, and a set of rolling elements 9.

1. A method for restoring a steel structure for a steel component after heating characterized in that it comprises the steps of:
a) heating a steel component to a temperature of at least 1100° C.,
b) quenching the steel component to a temperature above the martensite start temperature (Ms) to form bainite, and maintaining the steel component at that temperature for a holding time sufficient for transformation of all austenite to bainite,
c) re-heating the steel ring to a temperature of at least 580° C. but below the Ac₁ transformation temperature, and maintaining the steel ring at that temperature for the steel ring to exhibit a hardness of 45 Rockwell hardness C or below,
d) cooling the steel ring.

2. Method according to claim 1, characterized in that step a) comprises forming the steel component by hot rolling, forging and/or hot drawing at a temperature of at least 1100° C.

3. Method according to claim 1, characterized in that step a) comprises welding the steel component at a temperature of at least 1100° C. to form a welding joint.

4. Method according to claim 3, characterized in that the welding joint is a flash butt welded joint.

5. Method according to claim 1, characterized in that comprises quenching the steel component to a temperature above Ms and below 450° C. to form bainite, and maintaining the steel component at that temperature for a holding time sufficient for transformation of all austenite to bainite.

6. Method according to claim 1, characterized in that step b) comprises quenching the steel component to a temperature of 300 to 350° C. to form bainite, and maintaining the steel component at that temperature for a holding time sufficient for transformation of all austenite to bainite.

7. Method according to claim 1, characterized in that the steel component is a high-carbon steel component.

8. Method according to claim 1, characterized in that the steel component is a bearing component.

9. Method according to claim 8, characterized in that the bearing component is a bearing ring.

10. Steel component characterized in that it is manufactured using a method for restoring a steel structure for a steel component after heating characterized in that it comprises the steps of
a) heating a steel component to a temperature of at least 1100° C.,
b) quenching the steel component to a temperature above the martensite start temperature (Ms) to form bainite and maintaining the steel component at that temperature for a holding time sufficient for transformation of all austenite to bainite,
c) re-heating the steel ring to a temperature of at least 580° C. but below the Ac₁ transformation temperature, and maintaining the steel ring at that temperature for the steel ring to exhibit a hardness of 45 Rockwell hardness C or below, and
d) cooling the steel ring.

11. Steel component according to claim 10, characterized in that it is a steel ring.

12. Steel component according to claim 11, characterized in that it is a bearing ring.
